(19) United States
(12) Patent Application Publication
(10) Pub. No.: US 2010/0221513 A1
(43) Pub. Date: Sep. 2, 2010

(54) SELF SINTERING TRANSPARENT NANOPOROUS THIN-FILMS FOR USE IN SELF-CLEANING, ANTI-FOGGING, ANTI-CORROSION, ANTI-EROSION ELECTRONIC AND OPTICAL APPLICATIONS

(75) Inventors: Marc A. Anderson, Madison, WI (US); Jeffrey R. Brownson, Madison, WI (US); Jennifer Sanfillipo, Slinger, WI (US); Kevin Leonard, Madison, WI (US)

Correspondence Address: Patent Docket Department;Armstrong Teasdale LLP, 7700 Forsyth Boulevard, Suite 1800, St. Louis, MO, 63105, US

(73) Assignee: WISCONSIN ALUMNI RESEARCH FOUNDATION, Madison, WI (US)

(21) Appl. No.: 12/555,580

(22) Filed: Sep. 8, 2009

Related U.S. Application Data
(60) Provisional application No. 61/094,460, filed on Sep. 5, 2008.

(51) Int. Cl. C04B 35/01; B32B 17/06; C04B 35/46; C04B 35/14; B32B 27/06

(52) U.S. Cl. 428/216; 428/448; 428/412; 428/432; 428/428

(57) ABSTRACT

The invention is directed to an article made by the steps comprising providing either a plastic or glass substrate member, pre-heating the substrate member, providing a first liquid sol comprising water, methanol, and nanoparticulate SiO₂, coating the pretreated substrate member with a barrier layer of the first liquid sol, evaporating the water and methanol from the barrier layer at a temperature and for a duration sufficient to evaporate the water and methanol and insufficient to significantly thermally sinter the nanoparticulate SiO₂, providing a second liquid sol comprising water, methanol, nanoparticulate TiO₂, coating the barrier-coated substrate member with a top layer of the second liquid sol, and, evaporating the water and methanol from the top layer at a temperature and for a duration sufficient to evaporate the water and methanol and insufficient to significantly thermally sinter the nanoparticulate SiO₂ and TiO₂ to produce barrier and top coated substrate member.

### CROSS REFERENCE TO RELATED APPLICATIONS

This application discloses technology similar to that disclosed in U.S. Provisional Application Ser. No. 61/094,460 filed on Sep. 5, 2008, which is hereby incorporated herein by reference.

### STATEMENT REGARDING FEDERALLY SPONSORED RESEARCH & DEVELOPMENT

Not applicable.

### BACKGROUND OF THE INVENTION

It has been recently reported that there exists a growing interest in large-scale commercialization of optimally transparent, ceramic, inorganic oxide, thin-films that are self-cleaning, anti-microbial and/or anti-fogging. (Fujishima A et al., 2005, Titanium dioxide photocatalysis present situation and future approaches, C. R. Chimie 8).

Self-cleaning applications include windows, tiles, metals, ceramics, wood, paper, cardboard, concrete, stucco, tents, sails, shingles, lamp fixtures for tunnels, bathroom mirrors, aquariums, automotive glass, corrective eyewear, and others. Particularly, in one exemplary embodiment, there is a desire for self-cleaning solar panels and reflectors. Solar energy is a multi-billion dollar market, and countries all over the world have invested in solar collection systems. Deserts and their intense solar activity are ideal locations for these plants, however, although the sun's intensity is impressive, the dirt and dust is daunting. Power plants spend substantial amounts of money cleaning solar panels and reflectors as the accumulated dirt is detrimental to the efficiency of the system.

In many applications, thin oxide films are coated onto glass or ceramic tile substrates and sintered at temperatures in excess of 200° C. (Richerson D, 1982, Modern Ceramic Engineering: Properties, Processing, and Use in Design, Marcel Dekker, Inc.). The sintering process causes oxide particles to covalently bond to each other as well as to the substrate resulting in a hard and durable thin-film. (Fujishima A. et al., 2002, Titanium Dioxide Photocatalyst, U.S. Pat. No. 6,387,944).

However, sintering at high temperature is incompatible with substrates constructed from materials such as plastics, wood, or composite materials. The substrates generally cannot withstand the high temperatures needed to sinter many oxide films.

In some cases organic polymer films have been used on substrates that are incompatible with high sintering temperatures. In some cases polymeric films have been used for some applications such as those needing anti-fogging or self cleaning properties.

However, over time, photodecomposition causes such polymeric coatings to yellow. Hence, there is a need for durable thin-films constructed from inorganic ceramic oxides that harden at lower temperatures suitable for use with plastics, composites, woods or metals. Examples of suitable temperatures may include room temperature, the softening temperature, melting temperature, annealing temperature or decomposition temperature of the substrate to which the inorganic ceramic oxide films are applied.

### SUMMARY OF THE INVENTION

One aspect of the invention is an article made by the steps comprising providing a plastic substrate member, pretreating the plastics substrate member, providing a first liquid sol comprising water, methanol, and nanoparticulate SiO₂, coating the pretreated plastic substrate member with a barrier layer of the first liquid sol, evaporating the water and methanol from the barrier layer, providing a second liquid sol comprising water, methanol, nanoparticulate TiO₂, coating the barrier-coated plastic substrate member with a top layer of the second liquid sol, and, evaporating the water and methanol from the top layer to produce barrier and top coated plastic substrate member.

In one exemplary embodiment, the evaporating the water and methanol from the barrier layer is conducted at a temperature and for a duration sufficient to evaporate the water and methanol and insufficient to significantly thermally sinter the nanoparticulate SiO₂, and the evaporating the water and methanol from the top layer is conducted at a temperature and for a duration sufficient to evaporate the water and methanol and insufficient to significantly thermally sinter the nanoparticulate SiO₂ and TiO₂.

In an exemplary embodiment of the article, the first liquid sol further comprises nanoparticulate ZrO₂.

In another exemplary embodiment of the article, the mol ratio ZrO₂:SiO₂ is in the range of 20:80 to 30:70, whereby transparency was achieved. For other applications where transparency is not required, other ratios may be used. For example, TiO₂ alone, ZrO₂ alone, or SiO₂ alone may be used. Alternatively, other mol ratios of ZrO₂:SiO₂ include 20:80, 30:70, and 50:50. In another exemplary embodiment the 20:80 and 30:70 mixes consistently yielded unexpectedly superior clarity.

In another exemplary embodiment of the article, the second liquid sol further comprises nanoparticulate SiO₂.

In another exemplary embodiment of the article, the mol ratio TiO₂:SiO₂ is in the range of 20:80 to 30:70.

In another exemplary embodiment of the article, the plastic substrate member is constructed from a polycarbonate.

In another exemplary embodiment of the article, the substrate member is constructed from glass.

In another exemplary embodiment of the article, the film thickness of each of the barrier and top layers after evaporation of the water and methanol is in the range of 50 nm to 1000 nm.

In another exemplary embodiment of the article, the film thickness of each of the barrier and top layers after evaporation of the water and methanol is in the range of 248.7 nm to 295.8 nm.

In another exemplary embodiment of the article, the step of pretreating the plastic member comprises treating with HNO₃, cleaning with soap and ultra pure water, treating with KOH and/or irradiating with UV light.

In another exemplary embodiment of the article, the step of evaporating the water and methanol from the first layer comprises heating the first layer to 80° C. to 200° C. for 10 minutes to one hour.

In another exemplary embodiment of the article, the step of evaporating the water and methanol from the second layer comprises heating the second layer to 80° C. to 200° C. for 10 minutes to one hour.

In another exemplary embodiment of the article, the step of evaporating the water and methanol from each layer comprises drying without heating, such as drying at a temperature of from about 25° C. to about 150° C. for 10 minutes to one hour.

Another aspect of the invention is an article made by the steps comprising providing a glass substrate member, pretreating the glass substrate member, providing a liquid sol comprising water, methanol, and nanoparticulate TiO₂, coating the pretreated glass substrate member with a first layer of the liquid sol, and, evaporating the water and methanol from the first layer.

In one exemplary embodiment, the evaporating of the water and methanol from the first layer is conducted at a temperature and for a duration sufficient to evaporate the water and methanol and insufficient to significantly thermally sinter the nanoparticulate TiO₂.

In an exemplary embodiment of the article, the liquid sol further comprises nanoparticulate ZrO₂.

In another exemplary embodiment of the article, the mol ratio TiO₂:ZrO₂ is in the range of 20:80 to 30:70.

In another exemplary embodiment of the article, the liquid sol further comprises nanoparticulate SiO₂.

In another exemplary embodiment of the article, the mol ratio TiO₂:SiO₂ is in the range of 20:80 to 30:70.

In another exemplary embodiment of the article, the article further comprises the steps of coating the first layer coated glass substrate member with a second layer of the liquid sol, and, evaporating the water and methanol from the second layer.

In one exemplary embodiment, the evaporating of the water and methanol from the second layer is conducted at a temperature and for a duration sufficient to evaporate the water and methanol and insufficient to significantly thermally sinter the nanoparticulate TiO₂.

In another exemplary embodiment of the article, the film thickness of the first and second layers after evaporation of the water and methanol is in the range of 249 nm to 296 nm.

In another exemplary embodiment of the article, the article further comprises the step of pretreating the glass member comprises treating with HNO₃, cleaning with soap and ultra pure water or irradiating with UV light. It should be recognized by one skilled in the art that while HNO₃, soap and ultra water, and UV light are mentioned, any other oxidants (e.g., sulfuric acid) known in the art could be used in the step of pretreating the glass member as generally, this pretreatment oxidizes the surface of the substrate. This pretreatment allows the sol to wet the substrate.

In another exemplary embodiment of the article, the step of evaporating the water and methanol from the first layer comprises heating the first layer to 80° C. to 200° C. for 10 minutes to one hour.

In another exemplary embodiment of the article, the step of evaporating the water and methanol from the second layer comprises heating the second layer to 80° C. to 200° C. for 10 minutes to one hour.

### BRIEF DESCRIPTION OF THE DRAWINGS OF THE EXEMPLARY EMBODIMENTS

FIG. 1 is a depiction of particles sintering into a morphed conglomeration of particles, whereby material is transported to create the conglomeration.

FIG. 2 is a depiction of particles sintering due to the subsequent conditions and in accordance with the equations set forth therein.

FIG. 3 is a depiction of the photo sintering process.

FIG. 4 is a graph showing the UV absorbance measured by a spectrophotometer of a plastic substrate that had been cleaned with soap and water.

FIG. 5 shows the results of the hardness test on coated and uncoated glass and coated and uncoated plastic on the carbon pencil scale.

FIG. 6 is a graph showing acetone degradation and spectra results for plastic coated with SiO₂/TiO₂ upon exposure to UV light for one hour.

FIG. 7 is a graph showing CO₂ production and spectra results for plastic coated with SiO₂/TiO₂ upon exposure to UV light for one hour.

FIG. 8 is a depiction showing the results of contact angle testing of an uncoated plastic substrate, a coated plastic substrate, and a coated and UV treated plastic substrate.

FIG. 9 is a graph showing acetone degradation for glass coated with SiO₂/TiO₂ upon exposure to UV light for 5 hours.

### DETAILED DESCRIPTION OF THE EXEMPLARY EMBODIMENTS

Data herein demonstrates that thin nanoporous films can be produced without thermal sintering. More particularly, the films can be applied to a variety of substrates without having to heat the film coating after being applied to the substrate. Specifically, it has been found that the sol mixtures as described herein are applied as a liquid and dried to leave a durable thin-film. The thin-films require no further processing once applied to the desired material and will only increase in strength over time.

The thin-films of the instant invention also possess several favorable properties like optical transparency, photocatalytic character, anti-fogging ability, corrosion resistance, abrasion resistance, mass transport barrier, index of refraction modification and conductive or magnetic properties much like their sintered counterparts. As such, the instant nanoporous films have applications to the following: self-cleaning surfaces such as windows, tiles, and bathroom and kitchen fixtures; anti-fogging surfaces such as glass and plastic refrigerator components; scratch resistance surfaces such as plastic lenses; and, barrier modifications such as oxygen diffusion for plastic bottles.

Furthermore, as these films are prepared using wet chemistry in which no harmful powders are used, the thin-films are unhazardous to nature.

The instant nanoporous thin-films also modify the physical and chemical properties of the substrates on which they are placed, such as optical, electrical, electronic, magnetic, thermal and other properties. The composition and particles may be optimized for a given application. For example, the composition and associated processes may be optimized for application to plastic and glass supports. Other suitable supports may include metals, ceramics, wood, paper, cardboard, concrete, stucco, tents, sails, shingles, and the like.

It has now been found that the thin-films of the present disclosure use ultraviolet (UV) light from the sun as an energy source to perform their functions. Specifically, the thin-films selectively absorb light in the UV range of below about 370 nm. Upon photo-excitation of the substrate member/material by incident UV radiation an electron will be excited from the valence band to the conduction band. If the energy is larger than the band gap of the material, a proton is left behind in the material (an electron ‘hole’). These electron-hole pairs are highly chemically active and react with surface —OH groups forming free radicals that cause the oxidative degradation of organic compounds on the substrate member. The end result of this reaction is water and carbon dioxide.

Nanoparticle Synthesis. A sol is a colloidal suspension in an aqueous or non-aqueous solution. The sols used herein were formed from alkoxides, which hydrolyze and polymerize producing polymers. As they grow, such polymers tend to form small nano-sized spheres; a process driven by the need to achieve lower surface energy. Sols can also be prepared from metal salts. The nano-sized particles are suspended in an aqueous solution and kept from aggregation by a charge or steric stabilization factors.

Silica, titanium, and zirconium nanoparticles are prepared. The primary particle size of the nanoparticles is less than 10 nanometers. Primary particle size depends upon the variables used in the preparation such as pH, [Metal]:[H2O] molar ratios, ionic strength and temperature. (See Xu Q, 1991, Physical-Chemical Factors Affecting the Synthesis and Characteristics of Transition Metal Oxide Membranes PhD Thesis University of Wisconsin-Madison).

After a stable sol is obtained, an application process is used to apply the sol to the substrate. Exemplary processes include dip-coating, spray-coating, imbibing, electro-depositing and others, which deposit a thin-film of sol unto the surface of the substrate. As the sol dries, water exits the thin porous film of particles leaving behind a more condensed matrix of particles on the surface of the substrate. Exemplary films are nanoporous and less than 20.0 or 0.5 micron in thickness. Thickness depends upon the application method and variables such as removal speed, number of coating, and other factors. Shown below is the chemical hydrolysis of the hydroxyl-containing and alkyl-containing metal oxide present in the nanoparticulate sols of the instant invention, whereby M is the metal or ceramic atom such as Si, Ti, Al or Zr, and, whereby R may be a variety of hydrocarbon moieties such as an alkyl.

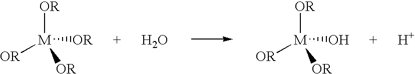

Shown below is the chemical condensation of two hydroxyl-containing, alkyl-containing, metal oxides upon thermally sintering the metal oxide, whereby the metal atoms are covalently bonded through an oxygen atom, and, whereby water or alcohol is generated

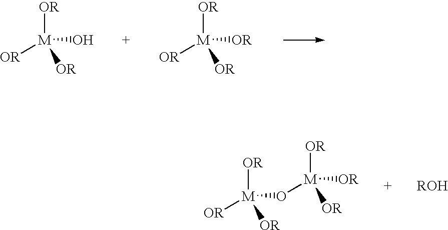

As linear polymeric-like chains are created, the chains fold and conform into spheres in order to achieve the lowest state of free energy. The sol may be created using two different chemical processes: hydrolysis and condensation. Various alkoxides have different hydrolysis reaction times. Silica has one of the slowest hydrolysis times, therefore, it is easier to control. Hydrolysis and condensation of silica produces very small particles. Other alkoxides, such as aluminum, have very fast hydrolysis rates that form clusters leading to the production of larger particles.

Sol Formation with Hydrolysis and condensation. During hydrolysis water combines with the alkoxide and produces a hydrolyzed molecule with an OH group in place of one OR group. Condensation combines these molecules with one another thereby forming chains having covalent bond linkages. During the condensation stage, OH and OR groups can combine producing either a ROH by-product or OH, and, OH groups can combine forming H₂O by-products. Polymer chains usually form small ball-like particles in order to reduce their surface free energy.

Sintering Models. Particles are created in suspension and used therefrom. Thin-films are made from these sols by the process of dip-coating, whereby the substrate is placed in the suspension and then withdrawn at a constant controlled speed. In other exemplary embodiments, the films are made using spray coating processes. The thickness of the thin-film is determined by the speed of withdrawal and the viscosity of the suspension. Resultant thin-films may be dried under controlled humidity to avoid cracking and delamination. The thin-films could be subsequently heated in a sol-gel to ceramic process. In the instant invention, the sols are advantageously self-sintering so only heat sufficient to evaporate the solvents.

A stable film is characterized by the formation of a matrix of particles covalently bonded together. Such bonding reduces the film porosity because the particles become more closely/tightly packed. Reduced pore size leads to densification of the film. Such particle bonding is commonly referred to as the sintering process. The sintering process transforms the material into a hard ceramic film.

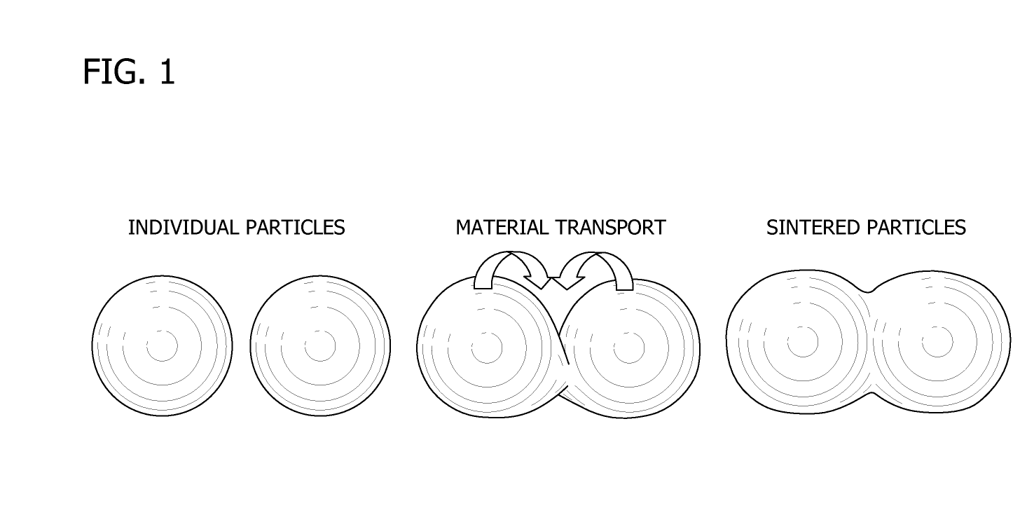

As the particles sinter they change from individual, discrete particles into a morphed conglomeration of particles. Material transports between particles to create that conglomeration. An illustration is shown in FIG. 1.

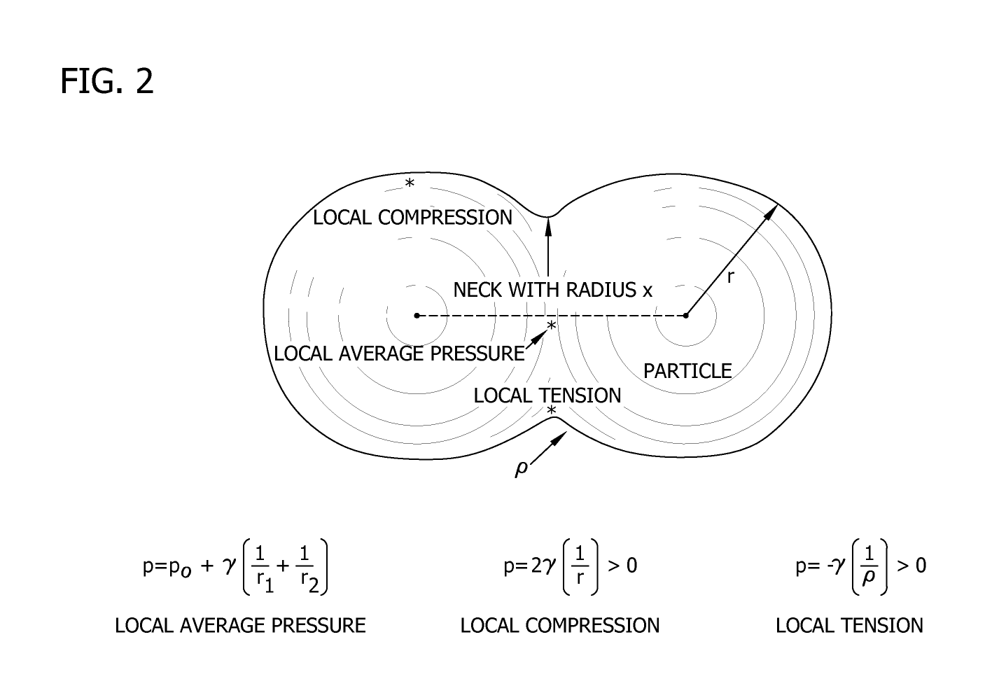

Exemplary Particle Sintering Process. It is theorized that surface tension forces, due to differences in curvature, drive the transport of material during the sintering process. Individual, discrete particles want to reduce the amount of surface free energy contained within them. The particles would rather be big with less curvature than small with high free energy. The illustration and equations shown in FIG. 2 may explain how particles proceed to sinter due to the subsequent conditions. In the local tension equation, γ is surface tension.

Particle Sintering Process Equations. It is theorized that the particles want to bond together, but may need additional specific energy to aid in the material transport. Energy may be provided to the system in the form of heat energy or photon energy. Sufficient heat or light waves provides enough energy to assist in material transport by exciting the particles.

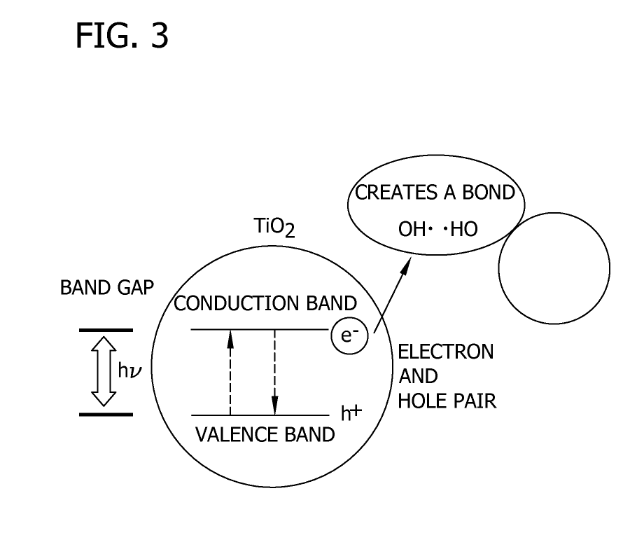

Heat Sintering Process. It is theorized that the heat energy causes atomic movement facilitating the translocation of material in an organized flow. Photo excitation may differ from heat excitation. During photo sintering, it is theorized that the energy within the light waves is adsorbed by particles having semiconducting character. The light energy may be larger than the band gap of the particle electron forming holes. These in turn react with surface OH groups forming free radicals facilitating reaction of OH groups with adjacent particles. Such bonding sinters the two particles together. An illustration of such is shown in FIG. 3.

Photo Sintering Process. Photo sintering is useful in semiconducting metal oxides such as titanium, tin, zirconia, manganese, iron, or other semiconductor materials. Conventional particles of silica or aluminum oxides, which have insulating properties, do not photo-sinter because the band gaps are too high. In other words, the light waves do not contain enough energy to eject an electron. However, the self-sintering systems of the instant invention can be photo sintered where any of the nanoparticles are semiconducting.

The extremely small nano-size of the instant particles provides very high surface free energy. Therefore, additional energy is not necessary to achieve sintering. The nanoparticles of the present invention sinter upon contact with one another (i.e., they self-sinter) in the absence of heat, light or other electromagnetic energy, thus, creating a hard ceramic film without the need for additional processing.

### EXAMPLES

### Example 1

Experimental. Preparation of Sols. Each sol was prepared by using sol-gel processes disclosed in Brownson, J R S et al., 2005, Surface Re-Esterfication and photo Sintering of Titania Xerogel Thin Films, Chemical Materials 17:3025-3030, which is hereby incorporated by reference. Acidic and basic sols were used throughout the examples. Where the sols were mixed, acidic sols were mixed with other acidic sols. Similarly, basic sols were mixed with other basic sols. Both procedures were used to prevent the aggregation of the particles and subsequent gellation of the suspensions. This was followed except in the case of TiO₂ and SiO₂, where an additional mixture was used of acidic TiO₂ and basic SiO₂ to promote an increased shelf-life.

Acid Sol Preparation. Titanium Dioxide (TiO₂) Sols. Titanium isoporoxide (Ti(OPi)₄) was added to a dilute solution of nitric acid (HNO₃) in a proportion of 1.65 mL to 21.4 mL. The mixture was stirred for 3 days to allow complete peptization (i.e., breaking up of larger aggregates of particles into a stable sol comprised of single nanoparticles).

In some cases, stirring was followed with dialysis to clean the sol of excess nitric ions and to adjust the final pH to 2.5. Dialysis of the sols included: filling dialysis bags with the peptized sol material, soaking it in an aqueous nitric solution having an approximate pH of 3.5 for 3 days, and, changing the water on average every 8 hours.

Zirconium Dioxide (ZrO₂) Sols. Zirconium peroxide (Zr(OPrn)₄) was combined in the proportion of 1.57 mL Zr(OPrn)₄ to 22 mL of dilute nitric acid and stirred. In some cases, the ZrO₂ sol was dialyzed to a final pH of approximately 2.3.

Silicon Dioxide (SiO₂) Sols. SiO₂ sol was prepared using tetraethyl orthosilicate (TEOS). The TEOS was mixed into an aqueous solution of nitric acid having a pH of 2.5. The mixture was stirred for 2 hours until hydrolysis was complete. No dialysis was used in the preparation of acidic SiO₂.

Basic Sol Preparation. Similar processes were used to produce the basic sols. In the case of titanium dioxide (TiO₂), titanium isoporoxide (Ti(OPi)₄) was added to a dilute solution of 1.22 M tetraethyl ammonium hydroxide (TEA) in a proportion of (91 mL H₂O:15 mL 1.22M TEA:7.5 mL Ti(OPi)₄). The mixture stirred for 2 hours at 80° C. to allow for the complete peptization (i.e., increasing the TEA yielded more clear sol shaving smaller particles). The reaction was stopped by storing the sol in teflon. In some cases, stirring was followed with dialysis to clean the sol of excess ammonium ions. The final pH was adjusted to 6.5-7.0.

A basic SiO₂ sol was prepared using tetraethyl orthosilicate (TEOS). The TEOS was mixed into an aqueous solution of ammonia (1 mL NH₃:30 mL H₂O) in a ratio of 4.5 mL TEOS:31 mL-NH₃ at pH of 2.5. The mixture was stirred for 2 hours until hydrolysis was complete. In some cases the sol was dialyzed once peptization was completed.

Preparation of Supports. Different Substrates were Coated with the sols and these coatings self-sintered into durable thin-films. To illustrate the self-sintering capability of the various films prepared from sols, several types of substrates were tested, such as polycarbonate and glass substrates. Plastic is an important substrate because it cannot be subjected to the normal high temperature sintering process. Glass is also important because it is uneconomical or impractical to heat in many situations particularly for glass windows or solar panels, new or existing (i.e., already in use).

Plastic Preparation. To prepare plastics for coating, care was taken to ensure that the surface was clean such that the nanoparticle-containing sols would “wet” the surface. Each sample was washed with soap and ultra pure water followed by a variety of trial treatments. The trial-cleaning procedures included soaking in alcohol, acid or base as well as heat annealing and/or UV irradiation.

Unlike glass, the plastic substrate required a pretreatment step for the sol to wet the plastic surface. As expected, plastic substrates were more difficult to wet than glass substrates. Wetting involves lowering the surface tension (i.e., surface free energy) of the substrate. By changing the surface tension of substrate, the surface can become wettable. By cleaning the surface, the surface free energy is increased allowing the surface to accept a coating, which in turn causes a lowering of its surface free energy. The surface may also be modified to possess hydrophilic qualities, which also improves wetting.

Table 1: Plastic Preparation. Table 1 shows combinations of sols used in the experiments herein. Each combination was tested to determine the optimal coating based on a desired function of the coated material (anti-fogging, scratch resistance, insulating, optical alterations, etc).

TABLE 1
Plastic Pretreatment

| Preparation# | Description |
|---|---|
| 1 | Soak in HNO₃ for 1 hour |
| 2 | Soak in KOH |
| 3 | Wash in soap and ultra pure water |
| 4 | Irradiate with UV light for various time |
| | increments |

Glass Preparation. Glass preparation was much less labor intensive than that for plastic. The hydrophilic character of glass allowed the sols to wet the surface more easily. In this example, the glass samples were washed with soap and water to remove any handling residue. The glass was dried using pressurized air. The instant coatings adhered to the cleaned glass without heating, UV annealing, or other sintering treatment.

Table 2 describes the combinations of sols used during the experiments herein. Each combination was tested to determine exemplary coatings and advantageous function(s) thereof

TABLE 2
Glass Pretreatment

| Preparation# | Description |
|---|---|
| 1 | Soak in HNO₃ for 1 hour |
| 2 | Wash in soap and ultra pure water |
| 3 | Irradiate UV for 1 hour |

Coating techniques. A variety of procedures for applying the thin films may be used, such as spin coating, sputter coating, spray coating, float coating, dip coating, electrodeposition and other known processes. Two exemplary methods used were dip-coating and spray-coating.

Coating Parameters. Plastic and glass substrates were coated using various combinations of sols, coating methods, and thin-film thickness. The sols were employed as follows.

TiO₂, ZrO₂, and SiO₂ were mixed with methanol to form a 57 mol % methanol solution. One sol mixture was made by combining ZrO₂ and SiO₂. Another sol mixture was made by combining TiO₂ and SiO₂. Both combinations were formulated at a 20:80 (metal oxide:SiO₂) ratio and at a 30:70 (metal oxide:SiO₂) ratio.

The predetermined number of applied coatings and other coating parameters determined the thickness of the thin ceramic films. Each coating was deemed a success or failure based on a sequence of tests assessing visual clarity, antifogging capability, contact angle, and scratch resistance. It is noted that such properties may not be important or critical for a given application or use. For example, glass generally requires optical transparency but it may not require the other properties.

Dipping and spraying processes were employed to apply the coating to the substrates. Retraction rate and sol viscosity control the film thickness in the dipping process. Two different rates of 2.4 mm/s and 5.1 mm/s were used in the dip-coating process, and the viscosity was predetermined by the sol parameters.

Regarding the spraying application process, jet force, conveyor speed, and the rate of sol delivery (using a syringe pump) generally determine film thickness. The following parameters were used with a Sono-Tech sprayer: Jet force of 10 L/min, conveyor speed in the range of 2-5 ft/min, and, sol flow rate in the range of 1-5 mL/min.

The application parameters were assessed by varying one parameter at a time. In an exemplary embodiment, the coating sufficiently wetted the substrate surface and ample hardness was obtained upon self-sintering. An exemplary jet force of 10 L/min provided sol droplets spread evenly across the surface producing a uniform coating.

Some exemplary environmental conditions provided an even coating. Incremental increases in temperature and relative humidity allowed particular environmental conditions to be tested. Superior coatings were obtained at an air temperature in the range of 22° C. to 27° C. Relative humidity values in the range of 46-66% also provided superior results. The superior results included clear and hard coatings.

Plastic Coatings. After pretreatment, two wet sol coatings were applied to the plastic substrate. The first coating functioned as a barrier (i.e., primer) between the plastic surface and the second (i.e., final) coating.

The sol mixture advantageously contains titanium dioxide to achieve the desirable characteristics of self-cleaning and anti-fogging. Titanium dioxide is photoactive (i.e., photocatalytic) so it has the ability to degrade surface-adhering organics. TiO₂ is also super-hydrophylic in character. TiO₂ degrades surface contaminant organic materials, but it may also degrade the substrate. To prevent substrate degradation, a barrier layer is applied to protect the plastic substrate.

The first coating of SiO₂ functions as a clear barrier or primer layer between the plastic substrate and the TiO₂-containing second coat, which functions as a clear topcoat. The coated samples were dried in an oven at 80° C. for one hour, which was warm enough to remove water from the sol wet coating. It is noted that 80° C. is not high enough of a temperature to heat-sinter the nanoparticles. Typically, heat sintering occurs above 200° C.

It should be recognized by one skilled in the art, that while the samples were dried in an oven, in some embodiments, the coated samples may be dried at room temperature (25° C.) or even lower. For example, in one or more embodiments, the samples may be dried at a temperature of from about 10° C. to about 200° C., more suitably, at a temperature of from about 25° C. to about 150° C., and even more suitably, from about 40° C. to about 100° C.

The plastic samples were dipped in the sol a second time at the same speed. Some of the coatings applied as a second film utilized the same mixture as the first coat and some were new composite mixtures. Various coating compositions and combinations were tested.

After applying the second coat, samples were placed under the same UV bulbs used for the one hour pre-treatment. The second coating was deemed a success or failure based on characterization collected on visual clarity, anti-fogging abilities, and scratch resistance testing as performed after the first coat.

Glass coatings. After pretreatment, a single coating of one sol was applied to each glass substrate. Due to the nature of the glass being non-degradable to TiO₂-containing coatings, no barrier coating was needed. Various sol compositions and combinations were tested. After the wet sol coating was applied, the coated glass was air-dried in ambient air.

Testing Techniques. Each substrate went through a series of tests. The tests included two categories. The first category is called coating characterization tests, which evaluated the substrate and the coating. The second category of tests is called application characterization tests, which evaluated how the coatings performed. The combination of results was used to determine the optimal coating. For example, the coating desirably adhered and self-cleaned.

Coating Characterization Tests. The coatings were characterized in a number of ways. First, each substrate went through preliminary testing before a coating was applied. Various tests were conducted: spectrophotometer measurements, contact angle measurements, hardness tests, FTIR analysis and, ellipsometry measurements.

Test Descriptions. Standard spectrophotometer testing recorded the transmission of wavelengths between 200-800 nm through the substrates. Spectrophotometer measurements show the UV sintering didn't affect the absorbance of the plastic. If different wavelengths are absorbed after UV sintering this would indicate that the properties and color of the plastic may have changed.

Standard contact angle measurements were conducted by placing a drop of ultra pure water (Milli-Q™) on the surface and measuring the angle between the substrate and a line tangent to the droplet surface. Three randomly selected places were tested, and the average value recorded using ASTM D7490 in which only water was used. Contact angle measurements demonstrate the hydrophilic or wetting properties of the coating.

Hardness testing was conducted by scratching the substrate with carbon pencils of different hardness according to ASTM D 3363. Hardness ranges from 4B to 9H, 4B being the softest. Hardness measurements show that the coating adhered and was not removed by scratching.

Thermogravimetry (TG) and Differential Thermal Analysis (DTA) data was collected on the plastic to determine the onset of sintering.

Ellipsometry measurements were gathered to determine the thickness of these coatings.

After preliminary testing of the substrates was complete, the first coating was applied. Again, all samples were subjected to another round of tests including visual clarity, anti-fogging, contact angle and scratch testing. These same tests were run again after the second coating was applied to plastics.

Application Characteristic Testing. The desired characteristic for these applications are, as mentioned herein, anti-fogging, self-cleaning, etc. Three tests were conducted to check our application characteristics: visual clarity, anti-fog ability, scratch resistance, and self-cleaning.

Visual clarity is essential for some optical applications. The visual clarity was based on whether the coating produced an iridescent appearance and if the coating was spotty. The property of having no iridescence and no spottiness was deemed an important criterion for a successful coating.

Anti-fogging tests involved blowing moist air at the surface in order to see a difference at the interface between coated and uncoated sample areas. Contact angle measurements are linked to the coating's anti-fogging abilities. The sol causes the surface to be hydrophilic and spread water droplets. Water vapors are easily attracted to the hydrophilic coating and will in turn have an anti-fogging effect.

Scratch resistance is based on the hardness of the thin film conducted during the coating characterization tests. A hard coating resists scratching better than a softer coating.

Self-cleaning capabilities were tested using Fourier Transfer Infrared (FTIR) analysis. In the FTIR testing, three 9″×1.5″ pieces of borosilicate glass pieces were placed in a 12″ long 2″ diameter glass cylinder. Three (3) 254-nm light bulbs were placed around the cylinder inline with the glass pieces inside. The system was flushed for 2 hours with 2 μl of acetone prior to lighting the bulbs. The system then ran for at least 3 hours with the ultraviolet lights powered on to activate the TiO₂ photocatalyst coating. Acetone and carbon dioxide peaks were compared before and after illumination using the FTIR instrument.

After initial screening, the options of possible coatings were narrowed and follow up tests were completed using the same procedures to verify repeatability.

Results. Substrate Preparation Testing. A variety of pretreatments were undertaken to prepare the surface. After significant experimentation with different soak concentrations, annealing time intervals, and combinations of each it was decided that a soap and water wash followed by one hour of UV annealing with a 254-nm bulb with an intensity of 0.26 to 0.45 mW/cm² held one to four inches away produced the best surface pretreatment for polycarbonate plastics.

This preparation treatment was optimized at one hour as less time did not fully allow the surface to be evenly covered and more time eventually degraded the plastic causing discoloration. When testing alternative preparation methods, discoloration also occurred. For example, submersing the polycarbonate in a potassium hydroxide soak caused yellowing as the solution attacked the material. Preparation methods utilizing alcohol and acid soaking did not transform the surface enough to allow the sols to wet the surface. For glass, as mentioned earlier, preparation simply includes washing in soap and water and drying with compressed air. It is noted that other procedure (such as those using peroxides or other materials that produce free radicals) would cause hydrolysis of the organics in the plastic substrate, which is also effective for preparation of the plastic surface.

Coating Characterization Test Results. The coatings that adhered and were not iridescent or spotty were ZrO₂:SiO₂ and TiO₂:SiO₂ at 30:70 mol %. All tests were administered using these coatings and produced the following results.

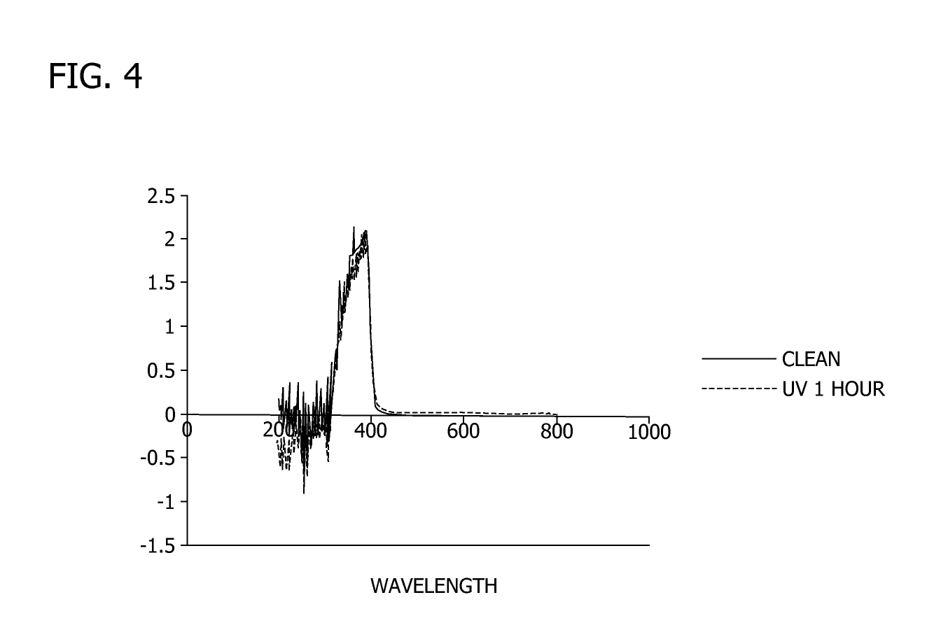

Spectrophotometer Results. Spectrophotometeter tests revealed that the UV preparation did not alter the plastic composition for absorption capabilities. The spectral data before and after UV treatment was the same. (See FIG. 4). Spectrophotometer results: One hour UV treatment did not significantly affect the plastic.

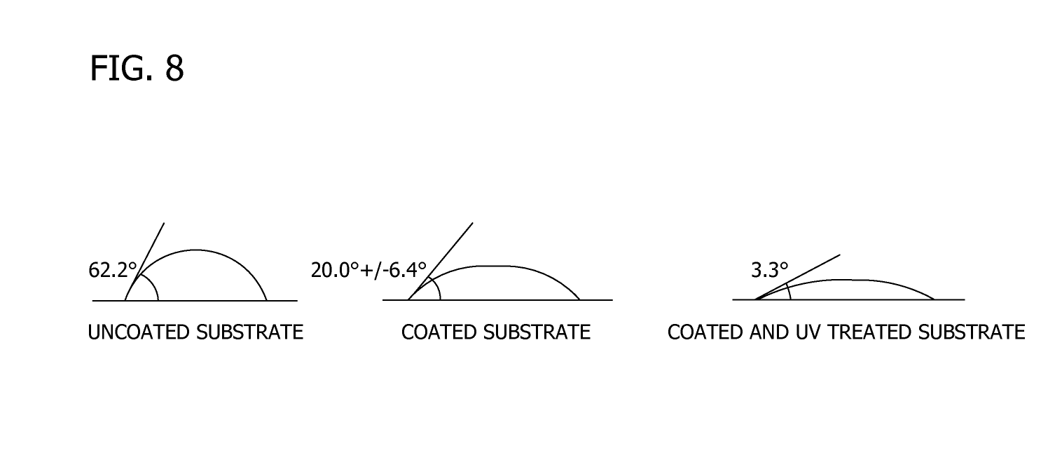

Contact Angle Results. For plastic substrates, contact angles were reduced overall, first from 62.2° on an uncoated surface to 20.0°±6.4° with the first coating and staying close at 23.0°±3.60° with the second coating, and, finally ending at approximately 3.3° after UV treatment. For glass, contact angles also reduced, first from 35.2° on an uncoated surface to a minimum of 6.6° with one first coating. (See FIG. 8). Contact Angle Test results are shown in Tables 3 and 4. Table 4 shows Contact Angle Test results for glass.

TABLE 3
Contact Angle Test Results for Plastic

| COATING | | | | | | | | |
|---|---|---|---|---|---|---|---|---|
| | COATING | | POST | CONTACT ANGLE | | | | |
| | DESCRIPTION | # | COATING | | | | | STD. |
| SAMPLE | (mol %) | COATINGS | TREATMENT | TRIAL 1 | TRIAL 2 | TRIAL 3 | AVE. | DEV. |
| 1 | none | 0 | none | 52.0 | 51.0 | 61.2 | 54.7 | 5.6 |
| 2 | none | 0 | none | 63.6 | 63.0 | 64.9 | 63.8 | 1.0 |
| 3 | TiO_{2:}SiO₂ | 1 | none | 23.2 | 19.0 | 21.0 | 21.1 | 2.1 |
| | 30:70 | | | | | | | |
| 4 | TiO_{2:}SiO₂ | 1 | Oven 1 h | 21.7 | 20.1 | 17.5 | 19.8 | 2.1 |
| | 30:70 | | @80° C. | | | | | |
| 5 | TiO_{2:}SiO₂ | 2 | Oven 1 h | 26.5 | 21.8 | 23.0 | 23.8 | 2.4 |
| | 30:70 | | @80° C. | | | | | |
| 6 | TiO_{2:}SiO₂ | 2 | UV sinter 1 h | 3.7 | 3.0 | 2.8 | 3.2 | 0.5 |
| | 30:70 | | | | | | | |
| 7 | TiO_{2:}ZrO₂ | 1 | Oven 1 h | 61.0 | 81.2 | 71.3 | 71.2 | 10.1 |
| | 30:70 | | @80° C. | | | | | |
| 8 | TiO_{2:}ZrO₂ | 2 | Oven 1 h | 45.9 | 48.0 | 38.0 | 44.0 | 5.3 |
| | 30:70 | | @80° C. | | | | | |
| 9 | TiO_{2:}ZrO₂ | 1 | UV sinter 1 h | 11.6 | 16.0 | 4.1 | 10.6 | 6.0 |
| | 30:70 | | | | | | | |
| 10 | TiO_{2:}ZrO₂ | 1 | Oven 1 h | 47.7 | 50.8 | 47.9 | 48.8 | 1.7 |
| | 30:70* | | @80° C. | | | | | |
| 11 | TiO_{2:}ZrO₂ | 2 | Oven 1 h | 22.2 | 20.6 | 23.1 | 22.0 | 1.3 |
| | 30:70* | | @80° C. | | | | | |
| 12 | TiO_{2:}ZrO₂ | 1 | UV sinter 1 h | 3.3 | 3.5 | 3.6 | 3.5 | 0.2 |
| | 30:70* | | | | | | | |

*Included excess methanol
Note:
All samples subjected to same sample preparation: UV sinter for 1 hour.

TABLE 4
Contact Angle Test Results for Glass

| COATING | | | | | | | | |
|---|---|---|---|---|---|---|---|---|
| | COATING | | POST | CONTACT ANGLE | | | | |
| | DESCRIPTION | # | COATING | | | | | STD. |
| SAMPLE | (mol %) | COATINGS | TREATMENT | TRIAL 1 | TRIAL 2 | TRIAL 3 | AVE. | DEV. |
| 1 | none | 0 | none | 34.8 | 35.7 | 35.0 | 35.2 | 0.5 |
| 2 | SiO₂ | 1 | none | 16.2 | 16.0 | 12.1 | 14.8 | 2.3 |
| 3 | TiO₂ | 1 | none | 40.5 | 31.7 | 34.9 | 35.7 | 4.5 |
| 4 | ZrO₂ | 1 | none | 10.0 | 6.4 | 3.5 | 6.6 | 3.3 |
| 5 | TiO_{2:}SiO₂ | 1 | none | 28.0 | 29.0 | 22.6 | 26.5 | 3.4 |
| | 30:70 | | | | | | | |
| 6 | ZrO_{2:}TiO₂ | 1 | none | 8.0 | 8.0 | 6.5 | 7.5 | 0.9 |
| | 30:70 | | | | | | | |
| 7 | TiO_{2:}SiO₂ | 1 | Exposed to UV | 0.0 | 1.5 | 0.9 | 0.8 | 0.8 |
| | 30:70 | | Light | | | | | |
| 8 | ZrO_{2:}TiO₂ | 1 | Exposed to UV | 12.8 | 12.5 | 11.4 | 12.2 | 0.7 |
| | 30:70 | | Light | | | | | |

*Included excess methanol
Note:
All samples subjected to same sample preparation: UV sinter for 1 hour.

Hardness Results. Hardness tests show the thin film scratch resistance. The uncoated plastic substrate had a hardness of H. After the first coating, hardness improved for both combinations by 6 levels to 6H and remained at that level for the rest of the testing. The uncoated glass substrate had a hardness of 9H. After coating, the hardness remained 9H.

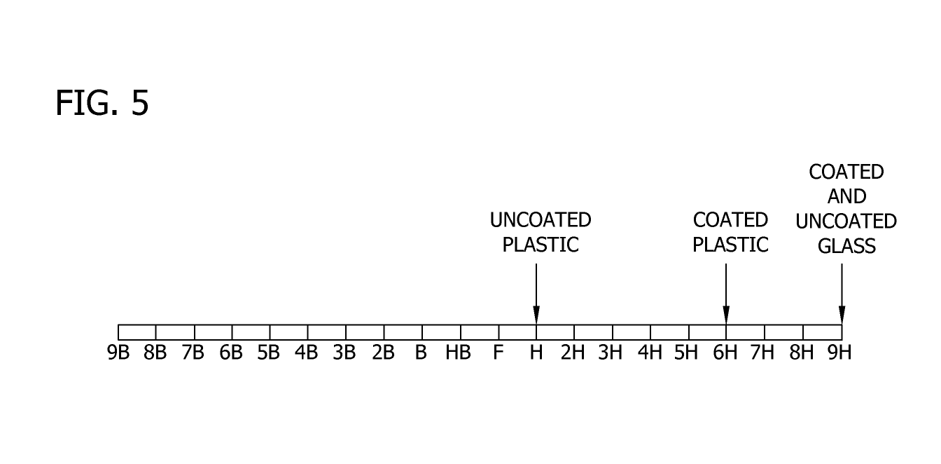

Hardness Test Results. Table 5 shows the results of the hardness tests for glass and plastic on the carbon pencil scale. (See also FIG. 5).

TABLE 5
Hardness Measurements for Plastics

| COATING | | | | | | | |
|---|---|---|---|---|---|---|---|
| | COATING | | | | | | |
| | DESCRIPTION | | POST COATING | HARDNESS | | | |
| SAMPLE | (mol %) | #COATINGS | TREATMENT | TRIAL 1 | TRIAL 2 | TRIAL 3 | TRIAL 4 |
| 1 | none | 0 | none | H | NA | | |
| 2 | none | 0 | none | 2H | NA | | |
| 3 | TiO_{2:}SiO₂ | 1 | none | 6H | 6H | | |
| | 30:70 | | | | | | |
| 4 | TiO_{2:}SiO₂ | 1 | Oven 1 h @ 80° C. | 7H | 6H | | |
| | 30:70 | | | | | | |
| 5 | TiO_{2:}SiO₂ | 2 | Oven 1 h @ 80° C. | 7H | 6H | | |
| | 30:70 | | | | | | |
| 6 | TiO_{2:}SiO₂ | 2 | UV sinter 1 h | 6H | 6H | | |
| | 30:70 | | | | | | |
| 7 | TiO_{2:}ZrO₂ | 1 | Oven 1 h @ 80° C. | 6H | 5H | 6H | 5H |
| | 30:70 | | | | | | |
| 8 | TiO_{2:}ZrO₂ | 2 | Oven 1 h @ 80° C. | 7H | 5H | 6H | |
| | 30:70 | | | | | | |
| 9 | TiO_{2:}ZrO₂ | 1 | UV sinter 1 h | 6H | 6H | 5H | 6H |
| | 30:70 | | | | | | |

All samples subjected to same Sample Preparation: UV sinter for 1 hour
Table 5: Hardness Test Results for Plastics - This table shows the results of each coating.

TABLE 6
Hardness Measurements for Glass

| COATING | | | | | |
|---|---|---|---|---|---|
| | COATING | | POST | | |
| | DESCRIPTION | | COATING | HARDNESS | |
| SAMPLE | (mol %) | #COATINGS | TREATMENT | TRIAL 1 | TRIAL 2 |
| 1 | none | 0 | none | NA | NA |
| 2 | none | 0 | none | NA | NA |
| 3 | TiO_{2:}SiO₂ | 1 | none | 9H | 9H |
| | 30:70 | | | | |
| 4 | TiO_{2:}SiO₂ | 1 | Oven 1 h @ | 9H | 9H |
| | 30:70 | | 80° C. | | |
| 5 | TiO_{2:}SiO₂ | 2 | Oven 1 h @ | 9H | 9H |
| | 30:70 | | 80° C. | | |
| 6 | TiO_{2:}SiO₂ | 2 | UV sinter 1 h | 9H | 9H |
| | 30:70 | | | | |
| 7 | TiO_{2:}ZrO₂ | 1 | Oven 1 h @ | 9H | 9H |
| | 30:70 | | 80° C. | | |
| 8 | TiO_{2:}ZrO₂ | 2 | Oven 1 h @ | 9H | 9H |
| | 30:70 | | 80° C. | | |
| 9 | TiO_{2:}ZrO₂ | 1 | UV sinter 1 h | 8H | 7H |
| | 30:70 | | | | |

Note:
All samples subjected to same Sample Preparation: wash with soap and water

Ellipsometery Results. Ellipsometry measurements were used to determine film thickness as well as consistency in thickness. In comparison to an uncoated sample, ellipsometry revealed a film thickness of about 275 nm. Values varied from 249 nm to 296 nm in total thickness after all coatings had been applied.

Application Characterization Test Results. Based on the coating characterization tests, those coatings that adhered to the substrate, reduced the contact angle, and increased the hardness were also tested using the application characterization tests.

Visual. If the coating was visibly spotty or iridescent, then it failed the visual test. Adhesion is directly affected by wetting. When a surface is wettable, the coating attaches itself rather then beading and running off the surface. The coatings that were non-iridescent and adhered were visually clear. Such coatings included ZrO₂: SiO₂ and TiO₂: SiO₂ at 30:70 mol % on both glass and plastic.

Anti-fogging. The anti-fog characteristic is quantified using contact angle measurements. Immediately following the UV treatment after the second coating is applied to the plastic, the contact angle was 3.2°, which was far lower than the 62.2° prior to treatment. After allowing the coating to sit in the dark, the contact angle increased to 31.2°, When UV light is introduced to the sample, the contact angle decreases to 14.9° after one hour. Contact angle decreased to 4.2° after 2 hours.

Scratch Resistance. Hardness testing showed that the instant coatings adhered to the surface and increased scratch resistance. Furthermore, the hardness levels and the absence of flaking also demonstrated the ability of the instant coatings to sinter without heat treatment.

Self-Cleaning Photocatalytic properties were observed after FTIR testing as acetone levels decreased and carbon dioxide levels increased in the presence of light. One sample with one coat of TiO₂ was tested.

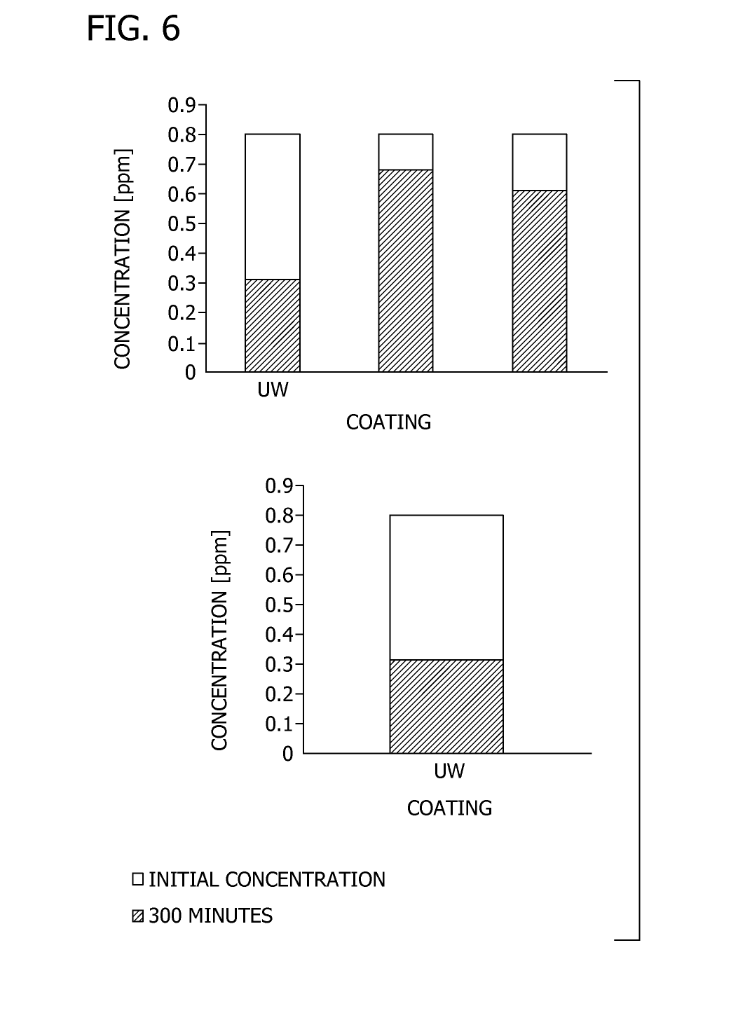

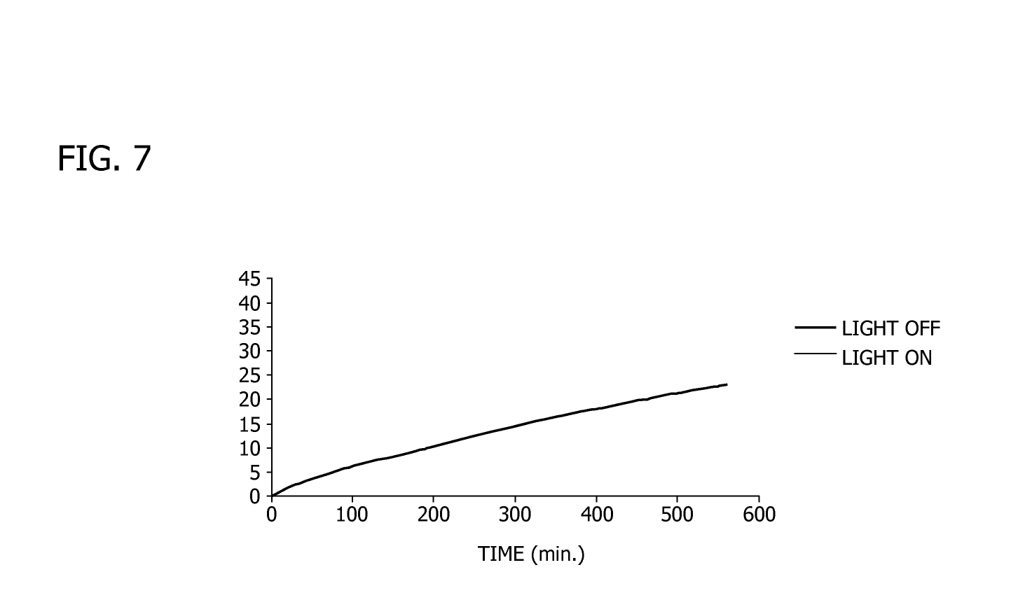

FIGS. 6 and 7 are graphs showing spectra results of plastic after exposed to UV light for one hour. As seen in FIGS. 6 and 7, photo activation of the catalyst occurred. As shown in the acetone degradation curve, the acetone level drops once the light is turned on. Light is added to the system for photocatalysis only—not as a sintering mechanism. As acetone levels drop, carbon dioxide levels increase as carbon dioxide is a byproduct of the oxidation of acetone.

It is hypothesized that the pretreatments allow all glass and plastic substrates to coat similarly. Several types of plastics were tested. After initial experimentation, it was determined that slight adjustments in coating dip rates (2.4-5.1 mm/sec), UV sintering pre-treatment times (0.5-3 hr), and quantities of alcohols added to the metal oxides (0.43-0.65 mol %) allowed the coatings to adhere to a variety of different substrates.

From these preliminary tests ZrO₂:SiO₂ and TiO₂:SiO₂ 30:70 mol % combinations were selected. A molar ratio of 20:80 caused patching of the sol on the substrate, so it did not coat the plastic as effectively as the 30:70 ratio. The 30:70 coating also had the highest clarity and anti-fogging ability. While coating polycarbonate substrates, two layers of the TiO₂:SiO₂ sol appeared clear and demonstrated anti-fogging ability. For the ZrO₂:SiO₂ on polycarbonate the standard mixture of sol (including methanol in each case) adhered, but the contact angle was lower where the solution contained extra methanol. The ZrO₂:SiO₂ was used as a first coat followed by a TiO₂:SiO₂ coat. When coating glass, one coat of TiO₂:SiO₂ was sufficient to produce the desired characteristics. Various combinations of coatings can be selected to emphasize the following characteristics: substrate preparation, clarity, anti-fogging, hardness, self-cleaning, and thickness.

Substrate Preparation. The plastics were prepared using UV irradiation at an intensity of 0.36 mW/cm² for one hour. This preparation allowed for enhanced wetting of the plastics with all the sol combinations. For glass substrates, a simple soap and water treatment followed by drying with compressed air increased wettability sufficient for sols to evenly coat. In both cases, with these pre-treatments, the coating did not flake off or bubble up on the substrate surface.

Clarity. Visual clarity was based on coating iridescence and spotting. Spotting occurred when the sol did not adhere properly and beaded on the surface. The surface preparation treatments and small additional amounts of methanol helped eliminate such problems.

Contact Angle and Anti-fogging. Contact angle measurements are linked to the anti-fogging ability of the coating. The sol causes the surface to be hydrophilic. Therefore, the water vapors are easily attracted to the coating. The contact angle decreases with the sol alone, therefore, the instant porous thin-films are absorbing some of the water molecules resulting in the spreading or wetting of the water on the substrate. Contact angle increases even more after being exposed to the UV light, which illustrates that photocatalytic processes alter the nature of the surface of the particles by producing free radicals that act to bind water better, thus reducing the appearance of fog.

It is theorized that photo activity (not just sintering) is pertinent to the anti-fogging abilities for two reasons. The non-photoactive SiO₂ coating alone failed to produce sufficient anti-fogging characteristics. However, the TiO₂:SiO₂ coatings successfully produced anti-fogging abilities. Since TiO₂ is photoactive, it is likely the cause of the improved anti-fogging capabilities. TiO₂ is altered by light having wavelengths in excess of band-gap energies. When the coatings sit for a few days in darkness, the anti-fogging abilities diminish. However, when the coating is again irradiated with UV light, the characteristics are restored, and, TiO₂ is reactivated to break down any organics that have filled the pores, thus making these systems more hydrophilic and anti-fogging. One coating of the TiO₂:SiO₂ sol appeared clear and to have anti-fogging abilities. Anti-fogging was more effective using two coatings of the TiO₂:SiO₂ sol.

Hardness and Scratch Resistance. Hardness testing demonstrated that adherence to the substrate and hardness of the coating was unexpectedly superior. Hardness measurements were performed using pencil testing. Hardness tests indicated resistance to scratching. As demonstrated by the results, the instant coatings adhered to both substrates. The ability of the substrate to accept a coating was increased with pretreatments and modifications to the sol combinations. The hardest coating was SiO₂:TiO₂.

Self-Cleaning. Examination of the FTIR data confirmed that the films were photocatalytic. Acetone concentrations maintained a constant level, and then decreased when UV bulbs were ignited. From that point onward, acetone levels decreased with rising carbon dioxide levels. That trend is consistent with typical photo activity.

Thickness. Ellipsometry measurements showed film consistency in terms of thickness. Thickness values varied from 249 nm to 296 nm in total thickness after all coatings had been applied. This data verifies the fact that the pretreatment techniques wetted the surfaces so that an even coating was applied, which yielded a consistent product.

Applications. The instant films possess desirable qualities (in the absence of thermal or photo sintering) such as hardness, anti-fogging properties, and the ability to degrade organics. Various sols can be combined in various ratios to achieve and emphasize certain properties. For instance, by combining a metal oxide (such as zirconium) with silica and methanol, scratch resistance is emphasized. Zirconium is very durable and creates a tough ceramic. The addition of silica evens out and assists in sintering the coating. Methanol in the sols assists to spread and wet a surface. Such coating may be used for scratch resistant lenses, car mirrors, windshields, and other end-products that would benefit from a durable thin coating

Sols may also be manipulated to increase self-cleaning properties. In an exemplary embodiment, titanium and silica are combined. Titanium is a degradation catalyst, and silica matches the substrates index of refraction. For example, in the case of self-cleaning windows, visibility through the window is very important. To maintain a clarity matching that of uncoated glass, the index of refraction desirably matches that of glass. Silica, which is a component in glass, maintains the coating's index of refraction at least roughly equal to that of glass alone. The index of refraction may also be modified to block or refract light for other applications. By coating a piece of glass and hanging it over a painting, harmful sun rays are directed away or absorbed by the coating, thus preserving the art. TiO₂ also absorbs UV, which is protective. Films having photocatalytic properties are also biocidal—killing organisms on contact if the film is exposed to UV light.

Silica coatings create anti-fogging characteristics for glasses. Use of insulating sols like zirconia change the material's conductivity. Gas diffusion can also be altered as a function of the size of the self-sintered pores. Since some of the materials absorb UV light, the self-sintering films can also be used to protect against harmful UV rays. Leaching, in the case of plastics, can be mitigated by using the instant films to keep plasticizers out of a contained liquid or to keep degrading materials in a liquid.

### Example 2

In this Example, sols composed of a mixture of silica dioxide (SiO₂) and titanium dioxide (TiO₂) as prepared in Example 1 were coated as thin-films onto various materials. The thin-films were then analyzed for durability and self-cleaning attributes.

Sols prepared above were applied to various materials such as glass substrates, PVC substrates, and a concrete sidewalk by spraying the sols with a spray gun onto the materials. The materials including the thin-films were exposed to all environmental weather conditions of Madison, Wis. for a period of approximately one year. After one year, the thin-films were analyzed.

Hardness testing was conducted using the ASTM D3363 test methods as described above. Specifically, hardness tests were conducted on the weakest thin-films (i.e., those composed only of TiO₂) to determine if the thin-films had been weakened or compromised. The results are shown in Table 7.

TABLE 7

| | | At Time of | 1 Year After |
|---|---|---|---|
| Sol Material | Material | Application | Application |
| TiO₂, 0.33 mol | Clear PVC | 4 H | 4 H |
| fraction | Glass | 6 H | 6 H |
| TiO₂, 0.57 mol | Clear PVC | 4 H | 4 H |
| fraction | Glass | 3.5 H | 4 H |

The results show that the materials are still attached and received a hardness level equal to or harder than the original material.

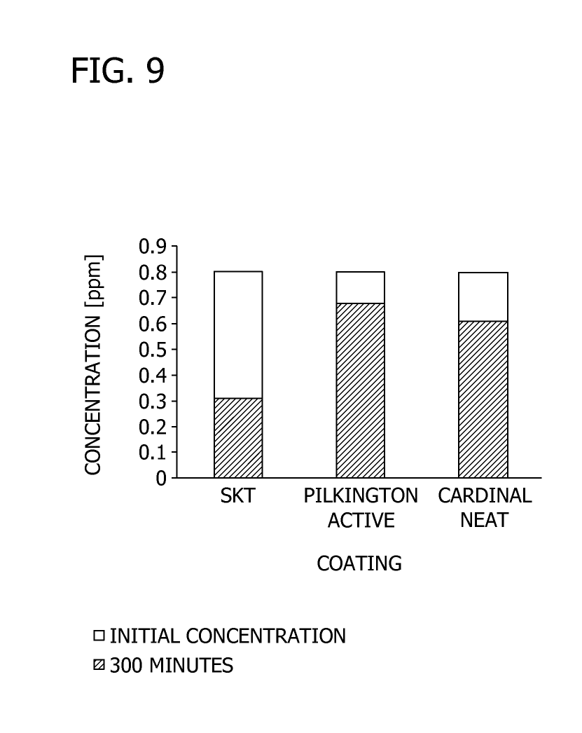

Additionally, glass coated with the thin-films was analyzed for self-cleaning using the analytical methods of Example 1. As shown in FIG. 9, there was an increase in acetone degradation of coated glass under UV radiation when compared to conventional self-cleaning glass (Pilkington Activ™, available from Pilkington Co., England, and Cardinal Neat®, available from Cardinal Glass Industries, Eden Prairie, Minn.). Specifically, samples of the same surface area of thin-film coated glass and conventional self-cleaning glass were subjected to identical initial concentrations of acetone. In 5 hours (300 minutes), the thin-film coated glass sample decreased the concentration of acetone by 61%. The commercially available self-cleaning glass samples decreased the concentration by 15% and 23%, respectively.

We claim:

1. An article made by the steps comprising:
providing a plastic substrate member,
pretreating the plastic substrate member,
providing a first liquid sol comprising water, methanol, and nanoparticulate SiO₂, coating the pretreated plastic substrate member with a barrier layer of the first liquid sol,
evaporating the water and methanol from the barrier layer, providing a second liquid sol comprising water, methanol, nanoparticulate TiO₂, coating the barrier-coated plastic substrate member with a top layer of the second liquid sol, and,
evaporating the water and methanol from the top layer to produce barrier and top coated plastic substrate member.

2. The article of claim 1, wherein the first liquid sol further comprises nanoparticulate ZrO₂.

3. The article of claim 2, wherein the mol ratio ZrO₂:SiO₂ is in the range of 20:80 to 30:70.

4. The article of claim 1, wherein the second liquid sol further comprises nanoparticulate SiO₂.

5. The article of claim 4, wherein the mol ratio TiO₂:SiO₂ is in the range of 20:80 to 50:50.

6. The article of claim 1, wherein the plastic substrate member is constructed from a polycarbonate.

7. The article of claim 1, wherein the film thickness of the barrier layer after evaporation of the water and methanol is in the range of 50 nm to 1000 nm, and, wherein the film thickness of the top layer after evaporation of the water and methanol is in the range of 50 nm to 1000 nm.

8. The article of claim 1, wherein the film thickness of the barrier layer after evaporation of the water and methanol is in the range of 249 nm to 296 nm, and, wherein the film thickness of the top layer after evaporation of the water and methanol is in the range of 249 nm to 296 nm.

9. The article of claim 1, wherein the step of pretreating the plastic member comprises treating with HNO₃, cleaning with soap and ultra pure water, treating with KOH and/or irradiating with UV light.

10. The article of claim 1, wherein the step of evaporating the water and methanol from the barrier layer comprises heating the barrier layer to 80° C. to 200° C. for 10 minutes to one hour.

11. The article of claim 1, wherein the step of evaporating the water and methanol from the barrier layer comprises drying the barrier layer at a temperature of from about 25° C. to about 150° C. for one hour.

12. The article of claim 1, wherein the step of evaporating the water and methanol from the top layer comprises heating the top layer to 80° C. to 200° C. for 10 minutes to one hour.

13. The article of claim 1, wherein the step of evaporating the water and methanol from the top layer comprises drying the top layer at a temperature of from about 25° C. to about 150° C. for one hour.

14. An article made by the steps comprising:
providing a glass substrate member,
pretreating the glass substrate member,
providing a liquid sol comprising water, methanol, and nanoparticulate TiO₂, coating the pretreated glass substrate member with a first layer of the liquid sol, and, evaporating the water and methanol from the first layer.

15. The article of claim 14, wherein the liquid sol further comprises nanoparticulate ZrO₂.

16. The article of claim 15, wherein the mol ratio TiO₂:ZrO₂ is in the range of 20:80 to 30:70.

17. The article of claim 14, wherein the liquid sol further comprises nanoparticulate SiO₂.

18. The article of claim 17, wherein the mol ratio TiO₂:SiO₂ is in the range of 20:80 to 30:70.

19. The article of claim 14, further comprising the steps of:
coating the first layer coated glass substrate member with a second layer of the liquid sol, and,
evaporating the water and methanol from the second layer.

20. The article of claim 19, wherein the film thickness of the first and second layers after evaporation of the water and methanol is in the range of 249 nm to 296 nm.

21. The article of claim 14, wherein the step of pretreating the glass member comprises treating with HNO₃, cleaning with soap and ultra pure water, treating with sulfuric acid, or irradiating with UV light.

22. The article of claim 14, wherein the step of evaporating the water and methanol from the first layer comprises heating the first layer to 80° C. to 200° C. for 10 minutes to one hour.

23. The article of claim 14, wherein the step of evaporating the water and methanol from the first layer comprises drying the first layer at a temperature of from about 25° C. to about 150° C. for 10 minutes to one hour.

24. The article of claim 19, wherein the step of evaporating the water and methanol from the second layer comprises heating the second layer to 80° C. to 200° C. for 10 minutes to one hour.

25. The article of claim 19, wherein the step of evaporating the water and methanol from the second layer comprises drying the second layer at a temperature of from about 25° C. to about 150° C. for 10 minutes to one hour.
